(19) United States
(12) Patent Application Publication
(10) Pub. No.: US 2026/0167569 A1
(43) Pub. Date: Jun. 18, 2026

(54) HYDROGEL-CEMENT COMPOSITE MATERIAL

(71) Applicant: SOUTHEAST UNIVERSITY, Nanjing (CN)

(72) Inventors: Jinyang JIANG, NANJING (CN); Jinyan SHI, NANJING (CN); Fengjuan WANG, NANJING (CN); Zhiyong LIU, NANJING (CN); Zeyu LU, NANJING (CN)

(21) Appl. No.: 19/379,686

(22) Filed: Nov. 4, 2025

(30) Foreign Application Priority Data
Dec. 13, 2024 (CN) 2024118349434

(51) Int. Cl. C04B 24/38; C04B 22/00; C04B 28/04; C04B 28/34; C04B 28/36; C08J 3/075; C08J 3/24; C08K 3/30; C08K 7/08

(52) U.S. Cl. CPC C04B 24/38; C04B 22/00867; C04B 28/04; C04B 28/34; C04B 28/36; C08J 3/075; C08J 3/24; C08K 3/30; C08K 7/08; C08J 2305/04; C08J 2329/04; C08K 2003/3045

(57) ABSTRACT

A hydrogel-cement composite material, wherein, including following raw materials in parts by weight: 99.5-99.98 parts of a cement, 0.02-0.5 parts of a strengthening hydrogel, and 80-100 parts of a water; and the strengthening hydrogel is prepared by adopting a method including following steps (1)-(5): in the step (1), uniformly mixing a polyvinyl alcohol solution and a sodium alginate solution, and stirring in an ice-water bath; and in the step (2), adding a cement hydration product phase-dispersion liquid of nano-ettringite whiskers, and uniformly stirring; and in the step (3), adding a calcium chloride solution, and carrying out a cross-linking reaction; and in the step (4), crushing and drying a cross-linking product to obtain solid particles; and in the step (5), soaking the solid particles in a mixture solution of a glutaraldehyde and a hydrochloric acid to obtain the strengthening hydrogel after soaking.

### CROSS REFERENCE TO RELATED APPLICATIONS

This application claims foreign priority of Chinese Patent Application No. 202411834943.4, filed on Dec. 13, 2024 in the China National Intellectual Property Administration, the disclosures of all of which are hereby incorporated by reference.

### TECHNICAL FIELD

The present disclosure relates to the technical field of grouting material, and in particular to a hydrogel-cement composite material (hydrogel-modified cement composite material, hydrogel-cement-based composite material).

### BACKGROUND

With the implementation of national strategies such as the maritime power and the belt and road initiative, engineering structures are increasingly moving towards complex service environments such as underwater and open sea. However, in the water-rich environment, harmful substances such as complex ions carried by water as a transmission medium invade the interior of concrete materials, which accelerates the deterioration of concrete structural performance. Therefore, it is urgent to develop the underwater repair materials and repair methods that are compatible with it. Underwater repair puts forward higher requirements for traditional repair materials. Under this background, the underwater anti-dispersion grouting materials have emerged as the times require, and it is widely used in projects such as water conservancy engineering, offshore oil platform, cross-river bridge, and cross-sea bridge. The underwater anti-dispersion grouting materials can be used for open caisson bottom sealing, cofferdam, caisson, riprap grouting, underwater continuous wall pouring, leveling and filling of underwater foundation, as well as large-diameter cast-in-situ pile, wharf, dam, reservoir repair, and other projects. In addition, it can also be used for underwater abutment, seawall revetment, slope protection, pile sealing and leakage plugging, as well as underwater projects that are difficult to construct with ordinary concrete.

The existing underwater anti-dispersion grouting materials mainly improve anti-dispersion, hardening rate, and early strength performance of cement-based grouting materials by adding additives. For example, the use of polycarboxylate superplasticizer can regulate the fluidity of cement paste; the sodium gluconate acts as a retarder to regulate the setting time; the early strength agent regulates the strength of cement paste; the hydroxyethyl methyl cellulose ether as an anti-dispersion agent improves the anti-dispersion performance of cement paste; the silica fume as a mineral additive improves the physical and mechanical properties of cement paste. However, this kind of underwater anti-dispersion grouting material is mostly used in underwater construction with low water flow speed, and the anti-dispersion agent of hydroxyethyl methyl cellulose ether adversely affects the hardening of cement-based grouting materials and affects its construction application under flowing water environment.

Accordingly, there is a need to provide an improved solution to the above-mentioned deficiencies of the prior art.

### SUMMARY

It is an object of the present disclosure to provide a hydrogel-cement composite material, in particular a hydrogel-cement composite grouting material under flowing water to facilitate the construction of grouting materials under flowing water and reduce the dispersion of grouting materials under flowing water.

In order to achieve the above-mentioned object, the present disclosure provides the following technical solutions: a hydrogel-cement composite grouting material under flowing water, wherein, including following raw materials in parts by weight: 99.5-99.98 parts of a cement, 0.02-0.5 parts of a strengthening hydrogel, and 80-100 parts of a water; and the strengthening hydrogel is prepared by adopting a method including following steps (1)-(5): in the step (1), uniformly mixing a polyvinyl alcohol solution and a sodium alginate solution, and stirring in an ice-water bath; a concentration of the polyvinyl alcohol solution and the concentration of the sodium alginate solution is 2 wt. %, and a mass ratio of the polyvinyl alcohol solution to the sodium alginate solution is (8-10): 9; and in the step (2), adding a dispersion liquid of nano-ettringite whiskers to a mixture obtained from the step (1), and uniformly stirring; the mass ratio of the nano-ettringite whiskers to the polyvinyl alcohol solution in the dispersion liquid of nano-ettringite whiskers is (2-2.5): 9; and in the step (3), adding a calcium chloride solution to a mixture solution obtained from the step (2), and carrying out a cross-linking reaction; a time of the cross-linking reaction is 2.5-3.5 h; and in the step (4), crushing and drying a cross-linking product obtained from the cross-linking reaction to obtain solid particles; and in the step (5), soaking the solid particles in the mixture solution of a glutaraldehyde solution and a hydrochloric acid solution to obtain the strengthening hydrogel after soaking.

### Advantageous Effects

The components of the hydrogel-cement composite grouting material under flowing water of the present disclosure include the strengthening hydrogel, which is helpful to greatly improve the underwater anti-dispersion ability of cement-based grouting materials, especially for the underwater grouting repair projects at high water flow speed.

Traditional anti-dispersion cement-based grouting materials are often compounded by additives such as the accelerator and thickener with the cement, and the cement paste is difficult to agglomerate after grouting (the traditional anti-dispersion cement-based grouting materials mainly improve the anti-dispersion performance by increasing the viscosity of grouting materials); the hydrogel-cement composite grouting material under flowing water of the present disclosure can adsorb and agglomerate the relatively dispersed cement-based grouting materials together by relying on the water absorption characteristics of strengthening hydrogel, and enhance the integrity of cement-based grouting materials (the strengthening hydrogel in the hydrogel-cement composite grouting material under flowing water of the present disclosure has little influence on the viscosity of grouting materials). In addition, the traditional underwater cement-based grouting materials are highly dependent on the content of additives, and the slight change of additive content can cause a significant change in the performance of grouting materials, resulting in large fluctuations in the performance and the small control interval of traditional grouting materials; the present disclosure mainly relies on the water control characteristics of strengthening hydrogel, and realizes the wide threshold control and precise design of grouting material performance by adjusting the parameters such as the water absorption ability of strengthening hydrogel, the setting time of cement paste, and the mass ratio of strengthening hydrogel to cement, which is conducive to the rapid repair of concrete structures at different water flow speeds.

### BRIEF DESCRIPTION OF THE DRAWINGS

FIG. 1 is a state diagram of a hydrogel-cement composite grouting material under flowing water according to an embodiment of the present disclosure.

### DETAILED DESCRIPTION OF THE EMBODIMENTS

The present disclosure provides a hydrogel-cement composite grouting material under flowing water to facilitate the construction of grouting materials under flowing water and reduce the dispersion of grouting materials under flowing water.

A hydrogel-cement composite grouting material under flowing water according to the embodiment of the present disclosure, wherein, including following raw materials in parts by weight: 99.5-99.98 parts (for example, 99.5 parts, 99.6 parts, 99.7 parts, 99.8 parts or 99.98 parts) of a cement, 0.02-0.5 parts (for example, 0.02 parts, 0.05 parts, 0.1 parts, 0.2 parts, 0.3 parts, 0.4 parts or 0.5 parts) of a strengthening hydrogel, and 80-100 parts (for example, 80 parts, 85 parts, 90 parts, 95 parts or 100 parts) of a water; and the strengthening hydrogel is prepared by adopting a method including following steps (1)-(5): in the step (1), uniformly mixing a polyvinyl alcohol solution and a sodium alginate solution, and stirring in an ice-water bath; and in the step (2), adding a dispersion liquid of nano-ettringite whiskers to a mixture obtained from the step (1), and uniformly stirring; and in the step (3), adding a calcium chloride solution to a mixture solution obtained from the step (2), and carrying out a cross-linking reaction; and in the step (4), crushing and drying a cross-linking product obtained from the cross-linking reaction to obtain solid particles; and in the step (5), soaking the solid particles in the mixture solution of a glutaraldehyde and a hydrochloric acid to obtain the strengthening hydrogel after soaking.

The hydrogel-cement composite grouting material under flowing water of the present disclosure can adsorb and agglomerate the relatively dispersed cement-based grouting materials together by relying on the water absorption characteristics of strengthening hydrogel (this strengthening hydrogel is prepared by a specific method with the sodium alginate and the polyvinyl alcohol as the main raw materials; if the sodium alginate or the polyvinyl alcohol is used alone, the gelling is affected), and enhance the integrity of grouting materials, thereby significantly improving the anti-dispersion performance of grouting materials under flowing water, which is conducive to the rapid repair of concrete structures under flowing water.

Preferably, the dosage of strengthening hydrogel is 0.2-0.5 parts.

In the hydrogel-cement composite grouting material under flowing water of a preferred embodiment of the present disclosure, in the step (1), a concentration of the polyvinyl alcohol solution and/or the concentration of the sodium alginate solution is 2 wt. %, and a mass ratio of the polyvinyl alcohol solution to the sodium alginate solution is (8-10): 9 (for example, 8:9, 8.5:9, 9:9, 9.5:9, or 10:9); the polyvinyl alcohol solution is prepared by dissolving a polyvinyl alcohol in a deionized water at 60-90° C. (for example, 60° C., 70° C., 80° C. or 90° C.).

In the hydrogel-cement composite grouting material under flowing water of a preferred embodiment of the present disclosure, the nano-ettringite whiskers are prepared by adopting the method including the following steps: uniformly mixing a sulphoaluminate cement clinker and the water, and carrying out a solid-liquid separation and a drying after a hydration is carried out at 60-70° C. (for example, 60° C., 62° C., 64° C., 66° C., 68° C. or 70° C.) for 70-74 h (for example, 70 h, 71 h, 72 h, 73 h or 74 h) to obtain the nano-ettringite whiskers; and the mass ratio of the sulfoaluminate cement clinker to the water is 1: (8-10) (for example, 1:8, 1:8.5, 1:9, 1:9.5 or 1:10).

In the hydrogel-cement composite grouting material under flowing water of a preferred embodiment of the present disclosure, the mass ratio of the nano-ettringite whiskers to the polyvinyl alcohol solution in the dispersion liquid of nano-ettringite whiskers is (2-2.5): 9 (for example, 2:9, 2.1:9, 2.2:9, 2.3:9, 2.4:9 or 2.5:9); in the step (2), after adding the dispersion liquid of nano-ettringite whiskers, the time of a stirring is 0.5-1.5 h (for example, 0.5 h, 0.8 h, 1.0 h, 1.2 h or 1.5 h; as long as the dispersion liquid of nano-ettringite whiskers and other raw materials can be uniformly mixed).

In the hydrogel-cement composite grouting material under flowing water of a preferred embodiment of the present disclosure, in the step (3), the concentration of the calcium chloride solution is 1.5 wt. %, and the mass ratio of the calcium chloride solution to the polyvinyl alcohol solution is 2-2.5 (for example, 2, 2.1, 2.2, 2.3, 2.4 or 2.5); in the step (3), a time of the cross-linking reaction is 2.5-3.5 h (for example, 2.5 h, 2.8 h, 3 h, 3.2 h or 3.5 h).

In the hydrogel-cement composite grouting material under flowing water of a preferred embodiment of the present disclosure, in the step (5), the mass ratio of the glutaraldehyde solution to the hydrochloric acid solution is (45-50):3 (for example, 45:3, 46:3, 47:3, 48:3, 49:3 or 50:3); and the concentration of the glutaraldehyde solution is 50 wt. %, and the concentration of the hydrochloric acid solution is 1 mol/L.

In the hydrogel-cement composite grouting material under flowing water of a preferred embodiment of the present disclosure, the cement is at least one of a Portland cement, a phosphate cement, and a sulphoaluminate cement.

The hydrogel-cement composite grouting material under flowing water of the present disclosure is described in detail below through the specific embodiments.

In the following embodiments: 72.5 grade sulfoaluminate cement is selected; the polyvinyl alcohol solution is obtained by dissolving the polyvinyl alcohol in the deionized water at a mass fraction of 2% (the Mw of polyvinyl alcohol is 89000-98000, 99% hydrolyzed); the sodium alginate solution is obtained by dissolving the sodium alginate (analytical grade, Aladdin) in the deionized water at the mass fraction of 2%; the CaCl₂) solution is a 1.5 wt. % CaCl₂ aqueous solution; the nano-ettringite whiskers are the sulfoaluminate cement clinker where the hydration is carried out at 70° C. for 72 h (water to solid ratio is 10) to obtain the nano-ettringite whiskers solution, and the dispersion liquid of nano-ettringite whiskers is obtained by the ultrasonic dispersion for 5 min; the glutaraldehyde solution is 50 wt. % deionized water solution of glutaraldehyde (analytical grade, Aladdin); the hydrochloric acid solution (1 mol/L) is a diluted solution of concentrated hydrochloric acid; the water is the deionized water; the ice water bath is provided by a magnetic stirring cold water bath pot with a water bath environment of 5° C., while the warm water bath is provided by a magnetic stirring hot water bath pot with a temperature between 60° C. and 90° C.; the stirring of grouting materials is completed by a rotary stirring mixer.

### Example 1

The hydrogel-cement composite grouting material under flowing water of the present example includes the following components by weight: 99.98 parts of a cement, 0.02 parts of a strengthening hydrogel, and 80 parts of a water.

Wherein, the raw materials of the strengthening hydrogel include the following components by weight: 45 parts of the polyvinyl alcohol solution, 45 parts of the sodium alginate solution, 10 parts of the nano-ettringite whiskers, 100 parts of the CaCl₂) solution, 94.34 parts of the glutaraldehyde solution, and 5.66 parts of a dilute hydrochloric acid solution.

The strengthening hydrogel is prepared by adopting a method including following steps (1)-(5): in the step (1), uniformly mixing the polyvinyl alcohol solution and the sodium alginate in a warm water bath, storing in the ice water bath, and stirring in a magnetic stirring water bath to polymerize, and a rotation speed of a rotor is 500 r/min; in the step (2), adding a dispersion liquid of nano-ettringite whiskers to the above mixture solution, and then stirring for 1 h; in the step (3), pouring the above solution into the CaCl₂) solution, and carrying out a cross-linking reaction for 3 h; in the step (4), putting the cross-linking product obtained in the above steps into a small crusher to crush for 1.5 min to obtain small particles (particle size is less than 0.5 cm), and further drying to obtain dried solid particles; in the step (5), in order to further improve the cross-linking degree, soaking it in the mixture solution of the glutaraldehyde solution and the hydrochloric acid solution (the mass ratio of the glutaraldehyde solution to the hydrochloric acid solution is 50:3) at room temperature for 1 h to obtain the strengthening hydrogel.

The cement, the water and the strengthening hydrogel (before mixing with the cement, the strengthening hydrogel prepared in the step (5) is washed and soaked to remove residual reaction raw materials) are mixed in a mortar stirring mixer according to the proportion, the rotation speed of mortar stirring mixer is 300 r/min, and the time of mixing is 120 s; a mixing instrument is stopped to obtain the hydrogel-cement composite underwater anti-dispersion grouting material.

### Example 2

The hydrogel-cement composite grouting material under flowing water of the present example includes the following components by weight: 99.95 parts of the cement, 0.05 parts of the strengthening hydrogel, and 80 parts of the water.

Wherein, the raw materials of the strengthening hydrogel include the following components by weight: 45 parts of the polyvinyl alcohol solution, 45 parts of the sodium alginate solution, 10 parts of the nano-ettringite whiskers, 100 parts of the CaCl₂) solution, 94.34 parts of the glutaraldehyde solution, and 5.66 parts of the dilute hydrochloric acid solution.

The strengthening hydrogel is prepared by adopting the method including following steps (1)-(5): in the step (1), uniformly mixing the polyvinyl alcohol solution and the sodium alginate in the warm water bath, storing in the ice water bath, and stirring in the magnetic stirring water bath to polymerize, and the rotation speed of rotor is 500 r/min; in the step (2), performing an ultrasonic dispersion on the nano-ettringite whiskers in the deionized water for 5 min, adding the above mixture solution, and then stirring for 1 h; in the step (3), pouring the above solution into the CaCl₂) solution, and carrying out the cross-linking reaction for 3 h; in the step (4), putting the cross-linking product obtained in the above steps into the small crusher to crush for 1.5 min to obtain the small particles (particle size is less than 0.5 cm), and further drying to obtain the dried solid particles; in the step (5), in order to further improve the cross-linking degree, soaking it in the mixture solution of the glutaraldehyde solution and the hydrochloric acid solution (the mass ratio of the glutaraldehyde solution to the hydrochloric acid solution is 50:3) at room temperature for 1 h to obtain the strengthening hydrogel.

The cement, the water and the strengthening hydrogel (before mixing with the cement, the strengthening hydrogel prepared in the step (5) is washed and soaked to remove the residual reaction raw materials) are mixed in the mortar stirring mixer according to the proportion, the rotation speed of mortar stirring mixer is 300 r/min, and the time of mixing is 120 s; the mixing instrument is stopped to obtain the hydrogel-cement composite underwater anti-dispersion grouting material.

### Example 3

The hydrogel-cement composite grouting material under flowing water of the present example includes the following components by weight: 99.90 parts of the cement, 0.10 parts of the strengthening hydrogel, and 80 parts of the water.

Wherein, the raw materials of the strengthening hydrogel include the following components by weight: 45 parts of the polyvinyl alcohol solution, 45 parts of the sodium alginate solution, 10 parts of the nano-ettringite whiskers, 100 parts of the CaCl₂) solution, 94.34 parts of the glutaraldehyde solution, and 5.66 parts of the dilute hydrochloric acid solution.

The strengthening hydrogel is prepared by adopting the method including following steps (1)-(5): in the step (1), uniformly mixing the polyvinyl alcohol solution and the sodium alginate in the warm water bath, storing in the ice water bath, and stirring in the magnetic stirring water bath to polymerize, and the rotation speed of rotor is 500 r/min; in the step (2), performing the ultrasonic dispersion on the nano-ettringite whiskers in the deionized water for 5 min, adding the above mixture solution, and then stirring for 1 h; in the step (3), pouring the above solution into the CaCl₂) solution, and carrying out the cross-linking reaction for 3 h; in the step (4), putting the cross-linking product obtained in the above steps into the small crusher to crush for 1.5 min to obtain the small particles (particle size is less than 0.5 cm), and further drying to obtain the dried solid particles; in the step (5), in order to further improve the cross-linking degree, soaking it in the mixture solution of the glutaraldehyde solution and the hydrochloric acid solution (the mass ratio of the glutaraldehyde solution to the hydrochloric acid solution is 50:3) at room temperature for 1 h to obtain the strengthening hydrogel.

The cement, the water and the strengthening hydrogel (before mixing with the cement, the strengthening hydrogel prepared in the step (5) is washed and soaked to remove the residual reaction raw materials) are mixed in the mortar stirring mixer according to the proportion, the rotation speed of mortar stirring mixer is 300 r/min, and the time of mixing is 120 s; the mixing instrument is stopped to obtain the hydrogel-cement composite underwater anti-dispersion grouting material.

### Example 4

The hydrogel-cement composite grouting material under flowing water of the present example includes the following components by weight: 99.80 parts of the cement, 0.20 parts of the strengthening hydrogel, and 80 parts of the water.

Wherein, the raw materials of the strengthening hydrogel include the following components by weight: 45 parts of the polyvinyl alcohol solution, 45 parts of the sodium alginate solution, 10 parts of the nano-ettringite whiskers, 100 parts of the CaCl₂) solution, 94.34 parts of the glutaraldehyde solution, and 5.66 parts of the dilute hydrochloric acid solution.

The strengthening hydrogel is prepared by adopting the method including following steps (1)-(5): in the step (1), uniformly mixing the polyvinyl alcohol solution and the sodium alginate in the warm water bath, storing in the ice water bath, and stirring in the magnetic stirring water bath to polymerize, and the rotation speed of rotor is 500 r/min; in the step (2), performing the ultrasonic dispersion on the nano-ettringite whiskers in the deionized water for 5 min, adding the above mixture solution, and then stirring for 1 h; in the step (3), pouring the above solution into the CaCl₂) solution, and carrying out the cross-linking reaction for 3 h; in the step (4), putting the cross-linking product obtained in the above steps into the small crusher to crush for 1.5 min to obtain the small particles (particle size is less than 0.5 cm), and further drying to obtain the dried solid particles; in the step (5), in order to further improve the cross-linking degree, soaking it in the mixture solution of the glutaraldehyde solution and the hydrochloric acid solution (the mass ratio of the glutaraldehyde solution to the hydrochloric acid solution is 50:3) at room temperature for 1 h to obtain the strengthening hydrogel.

The cement, the water and the strengthening hydrogel (before mixing with the cement, the strengthening hydrogel prepared in the step (5) is washed and soaked to remove the residual reaction raw materials) are mixed in the mortar stirring mixer according to the proportion, the rotation speed of mortar stirring mixer is 300 r/min, and the time of mixing is 120 s; the mixing instrument is stopped to obtain the hydrogel-cement composite underwater anti-dispersion grouting material.

### Example 5

The hydrogel-cement composite grouting material under flowing water of the present example includes the following components by weight: 99.50 parts of the cement, 0.50 parts of the strengthening hydrogel, and 80 parts of the water.

Wherein, the raw materials of the strengthening hydrogel include the following components by weight: 45 parts of the polyvinyl alcohol solution, 45 parts of the sodium alginate solution, 10 parts of the nano-ettringite whiskers, 100 parts of the CaCl₂) solution, 94.34 parts of the glutaraldehyde solution, and 5.66 parts of the dilute hydrochloric acid solution.

The strengthening hydrogel is prepared by adopting the method including following steps (1)-(5): in the step (1), uniformly mixing the polyvinyl alcohol solution and the sodium alginate in the warm water bath, storing in the ice water bath, and stirring in the magnetic stirring water bath to polymerize, and the rotation speed of rotor is 500 r/min; in the step (2), performing the ultrasonic dispersion on the nano-ettringite whiskers in the deionized water for 5 min, adding the above mixture solution, and then stirring for 1 h; in the step (3), pouring the above solution into the CaCl₂) solution, and carrying out the cross-linking reaction for 3 h; in the step (4), putting the cross-linking product obtained in the above steps into the small crusher to crush for 1.5 min to obtain the small particles (particle size is less than 0.5 cm), and further drying to obtain the dried solid particles; in the step (5), in order to further improve the cross-linking degree, soaking it in the mixture solution of the glutaraldehyde solution and the hydrochloric acid solution (the mass ratio of the glutaraldehyde solution to the hydrochloric acid solution is 50:3) at room temperature for 1 h to obtain the strengthening hydrogel.

The cement, the water and the strengthening hydrogel (before mixing with the cement, the strengthening hydrogel prepared in the step (5) is washed and soaked to remove the residual reaction raw materials) are mixed in the mortar stirring mixer according to the proportion, the rotation speed of mortar stirring mixer is 300 r/min, and the time of mixing is 120 s; the mixing instrument is stopped to obtain the hydrogel-cement composite underwater anti-dispersion grouting material.

### Example 6

The hydrogel-cement composite grouting material under flowing water of the present example includes the following components by weight: 99.50 parts of the cement, 0.50 parts of the strengthening hydrogel, and 100 parts of the water.

Wherein, the raw materials of the strengthening hydrogel include the following components by weight: 45 parts of the polyvinyl alcohol solution, 45 parts of the sodium alginate solution, 10 parts of the nano-ettringite whiskers, 100 parts of the CaCl₂) solution, 94.34 parts of the glutaraldehyde solution, and 5.66 parts of the dilute hydrochloric acid solution.

The strengthening hydrogel is prepared by adopting the method including following steps (1)-(5): in the step (1), uniformly mixing the polyvinyl alcohol solution and the sodium alginate in the warm water bath, storing in the ice water bath, and stirring in the magnetic stirring water bath to polymerize, and the rotation speed of rotor is 500 r/min; in the step (2), performing the ultrasonic dispersion on the nano-ettringite whiskers in the deionized water for 5 min, adding the above mixture solution, and then stirring for 1 h; in the step (3), pouring the above solution into the CaCl₂) solution, and carrying out the cross-linking reaction for 3 h; in the step (4), putting the cross-linking product obtained in the above steps into the small crusher to crush for 1.5 min to obtain the small particles (particle size is less than 0.5 cm), and further drying to obtain the dried solid particles; in the step (5), in order to further improve the cross-linking degree, soaking it in the mixture solution of the glutaraldehyde solution and the hydrochloric acid solution (the mass ratio of the glutaraldehyde solution to the hydrochloric acid solution is 50:3) at room temperature for 1 h to obtain the strengthening hydrogel.

The cement, the water and the strengthening hydrogel (before mixing with the cement, the strengthening hydrogel prepared in the step (5) is washed and soaked to remove the residual reaction raw materials) are mixed in the mortar stirring mixer according to the proportion, the rotation speed of mortar stirring mixer is 300 r/min, and the time of mixing is 120 s; the mixing instrument is stopped to obtain the hydrogel-cement composite underwater anti-dispersion grouting material.

### Comparative Example 1

The grouting material of the present comparative example includes the following components by weight: 99.98 parts of the cement and 80 parts of the water; the cement and the water are placed in the mortar stirring mixer, the rotation speed is 300 r/min, and the time of mixing is 120 s; the mixing instrument is stopped to obtain the grouting material of the present comparative example.

### Comparative Example 2

The difference between the present comparative example and Example 5 is only that the step (2) is omitted (i.e., the step of adding the nano-ettringite whiskers is omitted); the remainder is consistent with Example 5.

### Comparative Example 3

The difference between the present comparative example and Example 5 is only that the dosage of nano-ettringite whiskers in the step (2) is 20 parts; the remainder is consistent with Example 5.

### Comparative Example 4

The difference between the present comparative example and Example 5 is only that the dosage of nano-ettringite whiskers in the step (2) is 5 parts; the remainder is consistent with Example 5.

### Comparative Example 5

The difference between the present comparative example and Example 5 is only that the step (5) is omitted (i.e., the step of soaking the dried solid particles obtained in the step (4) in the mixture solution of the glutaraldehyde and the hydrochloric acid is omitted); the remainder is consistent with Example 5.

### Comparative Example 6

The difference between the present comparative example and Example 5 is only that in the step (3), pouring it into the CaCl₂) solution, and carrying out the cross-linking reaction for 1 h before proceeding to the step (4); the remainder is consistent with Example 5.

### Comparative Example 7

The difference between the present comparative example and Example 5 is only that in the step (3), pouring it into the CaCl₂) solution, and carrying out the cross-linking reaction for 5 h before proceeding to the step (4); the remainder is consistent with Example 5.

Performance testing: the scouring loss ratio (erosion loss ratio, scouring rate) of grouting materials in Examples 1-6 and Comparative Examples 1-7 mentioned above are tested.

Test method: in order to determine the underwater scouring loss ratio of grouting materials, each sample is tested three times; in a beaker containing 1000 ml of water, a culture dish is provided at the bottom, and an uniform speed stirring head with a speed of 250 r/min is provided on the water surface to simulate the water flow environment; during the process of uniform speed stirring of rotor, M₀ (50 g) of grouting materials is taken each time and grouted into the culture dish at the bottom of beaker (the grouting can be done with the help of the grouting tube), after 2 min, the culture dish is taken out, and the mass Mₙ of remaining grouting materials is weighed; the underwater scouring loss ratio of grouting materials is calculated by equation (1).

$$S = ( {M}_{0} - {M}_{n} ) / {M}_{0} \qquad ( 1 )$$

In the formula, S is the underwater scouring loss ratio of grouting materials; M₀ is the mass of initial grouting materials, which is 50 g in the present example; Mₙ is the remaining mass of grouting materials after 2 min (the composite grouting materials used in Examples 1-6 use the sulfoaluminate cement as a fast hardening cement, which allow the composite grouting materials in Examples 1-6 to harden quickly; the loss of grouting materials in the first 2 min of grouting can reach more than 85% of the total loss of grouting materials under flowing water; after 2 min of grouting, there is basically no more passive water scouring of a large amount of grouting materials; therefore, in the present disclosure, when the scouring loss ratio test is carried out, the early anti-dispersion performance of the grouting materials is characterized by testing the scouring loss ratio of grouting for 2 min under flowing water).

The results are shown in Table 1 below.

TABLE 1
Result tests of scouring loss ratio

| | Remaining paste mass | |
|---|---|---|
| Number | (g) | Scouring loss ratio |
| Example 1 | 18.6 | 62.8% |
| Example 2 | 23.5 | 53.0% |
| Example 3 | 27.5 | 45.0% |
| Example 4 | 33.2 | 33.6% |
| Example 5 | 41.6 | 16.8% |
| Example 6 | 38.9 | 22.2% |
| Comparative Example 1 | 12.5 | 75.0% |
| Comparative Example 2 | 23.6 | 52.8% |
| Comparative Example 3 | 31.6 | 36.8% |
| Comparative Example 4 | 29.8 | 40.4% |
| Comparative Example 5 | 30.4 | 39.2% |
| Comparative Example 6 | 34.6 | 30.8% |
| Comparative Example 7 | 36.8 | 26.4% |

According to the results in TABLE 1 mentioned above, in Examples 1-5, the mass loss ratios of grouting materials under flowing water are gradually decreased with the increase of content of strengthening hydrogel; when the mass ratio of the strengthening hydrogel/cement reaches 0.5%, the underwater loss ratio of grouting materials is only 16.8%. Compared with the Comparative Example 1, the scouring loss ratio of grouting materials under flowing water environment in Example 5 is reduced by 77.6%.

Compared with the Comparative Example 2, the grouting materials in Example 5 also have a significantly lower scouring loss ratio under flowing water environment, the mechanism of which is mainly that the nano-ettringite whiskers can improve the cross-linking degree of hydrogel, thereby improving its mechanical property and expansibility; on the other hand, the nano-ettringite whiskers can extend the underwater life of hydrogel, and improve the anti-dispersion and anti-aging property of hydrogel.

The experimental results of Comparative Examples 3, 4 and Example 5 show that only an appropriate amount of nano-ettringite whiskers can effectively improve the performance of hydrogel material, while too little or too much may hardly achieve similar effects.

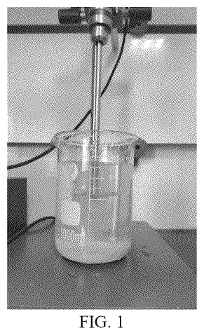

Comparing the experimental results of Comparative Examples 5, 6 and 7 with Example 5, it can be seen that the insufficient cross-linking time or excessive cross-linking may lead to poor hydrogel performance and affect the anti-dispersion performance of cement grouting materials; on the one hand, too short cross-linking time may reduce the water absorption rate of hydrogel, and reduce the agglomeration of grouting materials under flowing water environment; on the other hand, too long cross-linking time may cause poor toughness and easy breakage of hydrogel. In addition, it can be seen from FIG. 1 that under the action of flowing water, the sufficient content of strengthening hydrogel can significantly improve the anti-dispersion ability of grouting materials.

To sum up, the main reason why the use of strengthening hydrogel can significantly improve the anti-dispersion performance of fast-hardening cement grouting materials is that the strengthening hydrogel has a high specific surface area, and the fiber strengthening structure can adsorb the liquid cement paste mainly composed of water, thus hindering the dispersion of cement paste under flowing water, and improving the agglomeration of grouting materials. In addition, the hydrogel-cement composite grouting material under flowing water of the present disclosure has the following advantages as compared to the traditional anti-dispersion cement-based grouting materials: (1) the traditional anti-dispersion cement-based grouting materials tend to improve the anti-dispersion property of grouting materials by changing the cement components, such as using the silica fume, reducing the water-binder ratio, etc., while the present disclosure can achieve such effects without changing the cement components (the components of cement have less influence on the composite grouting material of the present disclosure); and changing the components of cement is equally applicable to the present disclosure, in which case the grouting material property can be further improved; (2) the traditional anti-dispersion cement-based grouting materials use the thickener and the early agent to improve the anti-dispersion property of grouting materials, and such disclosures sacrifice a part of the performance of grouting materials (for example, the use of thickener and early agent may often significantly reduce the early fluidity or pumpability of grouting materials, greatly shorten the grouting window period of grouting materials, and is inconvenient for construction, or the use of early strength agent may often cause the later intensity contraction (later strength retraction) of grouting materials), the strength of composite grouting material of the present disclosure can increase with the increase of age, and the intensity contraction is not occurred; (3) the performance control interval of traditional anti-dispersion cement-based grouting materials is small and the designability is poor, generally, the content of additives in traditional methods is low, and the slight change of additives may cause the performance of grouting materials to change greatly, resulting in weak controllability; the composite grouting material of the present disclosure can adjust the dosage ratio of strengthening hydrogel according to the actual needs (for example, the requirements of anti-dispersion performance), and has strong designability.

What is claimed is:

1. A hydrogel-cement composite grouting material under flowing water, wherein, comprising following raw materials in parts by weight: 99.5-99.98 parts of a cement, 0.02-0.5 parts of a strengthening hydrogel, and 80-100 parts of a water; and
the strengthening hydrogel is prepared by adopting a method comprising following steps (1)-(5):
in the step (1), uniformly mixing a polyvinyl alcohol solution and a sodium alginate solution, and stirring in an ice-water bath; a concentration of the polyvinyl alcohol solution and the concentration of the sodium alginate solution is 2 wt. %, and a mass ratio of the polyvinyl alcohol solution to the sodium alginate solution is (8-10): 9; and
in the step (2), adding a dispersion liquid of nano-ettringite whiskers to a mixture obtained from the step (1), and uniformly stirring; the mass ratio of the nano-ettringite whiskers to the polyvinyl alcohol solution in the dispersion liquid of nano-ettringite whiskers is (2-2.5): 9; and
in the step (3), adding a calcium chloride solution to a mixture solution obtained from the step (2), and carrying out a cross-linking reaction; a time of the cross-linking reaction is 2.5-3.5 h; and
in the step (4), crushing and drying a cross-linking product obtained from the cross-linking reaction to obtain solid particles; and
in the step (5), soaking the solid particles in the mixture solution of a glutaraldehyde solution and a hydrochloric acid solution to obtain the strengthening hydrogel after soaking.

2. The hydrogel-cement composite grouting material under flowing water according to claim 1, wherein, the polyvinyl alcohol solution is prepared by dissolving a polyvinyl alcohol in a deionized water at 60-90° C.

3. The hydrogel-cement composite grouting material under flowing water according to claim 1, wherein, the nano-ettringite whiskers are prepared by adopting the method comprising the following steps: uniformly mixing a sulphoaluminate cement clinker and the water, and carrying out a solid-liquid separation and a drying after a hydration is carried out at 60-70° C. for 70-74 h to obtain the nano-ettringite whiskers; and
the mass ratio of the sulfoaluminate cement clinker to the water is 1: (8-10).

4. The hydrogel-cement composite grouting material under flowing water according to claim 1, wherein, in the step (2), after adding the dispersion liquid of nano-ettringite whiskers, the time of a stirring is 0.5-1.5 h.

5. The hydrogel-cement composite grouting material under flowing water according to claim 1, wherein, in the step (3), the concentration of the calcium chloride solution is 1.5 wt. %, and the mass ratio of the calcium chloride solution to the polyvinyl alcohol solution is 2-2.5.

6. The hydrogel-cement composite grouting material under flowing water according to claim 1, wherein, in the step (5), the mass ratio of the glutaraldehyde solution to the hydrochloric acid solution is (45-50): 3; and
the concentration of the glutaraldehyde solution is 50 wt. %.

7. The hydrogel-cement composite grouting material under flowing water according to claim 1, wherein, the cement is at least one of a Portland cement, a phosphate cement, and a sulphoaluminate cement.
